(19) United States
(12) Patent Application Publication
(10) Pub. No.: US 2009/0164452 A1
(43) Pub. Date: Jun. 25, 2009

(54) APPARATUS AND MEHTOD FOR PERSONALIZATION ENGINE

(75) Inventors: Kumanan Yogaratnam, Ottawa (CA); Dat Doan, Toronto (CA)

Correspondence Address: VINCENT PATENT AGENCY, 11-300 EARL GREY DRIVE, SUITE 202, KANATA, ON, K2T 1C1, CA

(73) Assignee: ESPIAL GROUP INC., Ottawa (CA)

(21) Appl. No.: 11/963,548

(22) Filed: Dec. 21, 2007

(51) Int. Cl. G06F 17/30

(52) U.S. Cl. 707/5; 707/E17.143

(57) ABSTRACT

An apparatus and a method for a personalization engine for providing a user preference matching score for a media content item. Any of a plurality of media processing applications can submit a request including identification of the media content item and associated meta-data, and receive in response the user preference matching score. The requesting application can take actions responsive to the received user preference matching score. The user preference matching score is derived from information, collected by the personalization engine from a plurality of sources, including data pertaining to a plurality of pre-define fields that reflect the user's expressed preferences and the user's previous usage of other media content items. In deriving the user preference matching score, different weighting factors can be assigned to data in each of the pre-defined fields based on, for example, the source of the data and weighting factors specified by the requesting application.

### FIELD OF THE INVENTION

The present invention relates to the field of media content processing systems. In particular, to an apparatus and a method for a personalization engine that provides information, related to user preferences, to media applications that can take actions with respect to a media content item responsive to the information.

### BACKGROUND

In the field of media distribution (e.g. cable television (TV), interactive TV, Internet Protocol (IP) TV) the body of media content being offered to users (e.g. viewers) is constantly growing and tends to be growing at an increasing rate. Many users of media distribution systems can find the choice of media content items overwhelming and unmanageable. In an effort to address the users' surfeit of media content choices, systems have been developed that attempt to pre-select a sub-set of media content items, from the total available choices, which are likely to be of greater interest to the user (i.e. match the user's preference). Systems can then either present the user with the sub-set of media content or take other autonomous actions (e.g. recording or providing an alert) with regard to the sub-set of media content items.

The selection of the sub-set of media content items is typically based on user preferences that can be captured in the form of a user profile. Data contained in the user profile can be based on the user's responses to a plurality of preference questions (e.g. ranking selection alternatives), a history of the user's previous usage (e.g. viewing) of media content, or a combination of the user's responses and usage history.

For example, a media application such as an interactive program guide (IPG), running in a TV set-top-box (STB), can create one or more user profiles as described in the preceding paragraph. The IPG can use a given user profile to select a sub-set of available TV programs to recommend to the user in making a viewing selection. Typically, another application such as a digital video recorder (DVR), connected to the same source of TV program content (e.g. cable or satellite TV) as the IPG would create separate user profiles corresponding to the same users and use these profiles to select a sub-set of available TV programs to record for later viewing by the users.

The creation of a user profile based on the user's responses to a plurality of preference questions (e.g. choosing a most preferred characteristic from a set of characteristics or ranking a set of characteristics) is dependent on the user's cooperation in going through each of the preference selections and in the user making selections that are representative of his/her preferences.

The creation of a user profile based on the users usage (e.g. viewing) history results in the profile being developed/populated over time. When there is little history the profile may not be a good representation of the user's preferences. The quality of the user profile improves as more usage history is taken into consideration in the user profile.

When each of one or more applications uses a separate user profile, the user must go through a set of preference questions for each application that uses preference selections and a new history of usage must be generated for each application that uses usage history.

What is needed is a mechanism that allows user preference information to be shared amongst multiple media applications.

### SUMMARY OF INVENTION

An apparatus and a method for a personalization engine for providing a user preference matching score for a media content item. Any of a plurality of media processing applications can submit, to the personalization engine, a request including identification of the media content item and associated meta-data, and receive in response the user preference matching score. The requesting application can take actions with regard to the media content item (e.g. recommending the media content item to the user or recording the media content item) responsive to the received user preference matching score. The user preference matching score is derived from information collected by the personalization engine. The information is collected from a plurality of sources and stored by the personalization engine. The collected information includes data pertaining to a plurality of pre-define fields that reflect the user's expressed preferences and the user's previous usage of other media content items. In deriving the user preference matching score, different weighting factors can be assigned to data in each of the pre-defined fields based on, for example, the source of the data and weighting factors specified by the requesting application. The requesting application can optionally specify that the derivation of the user preference matching score be based on collected information associated with a specified time period.

In one aspect of the present invention there is provided, a method for a personalization engine for providing a user preference matching score for a media content item to any of a plurality of media processing applications, the method comprising the steps of: collecting user preference data from a plurality of data sources; processing and storing the collected data as information in a data storage medium; receiving a user preference matching score request, including identification of the media content item and meta-data associated with the media content item, from a media processing application from the plurality of media processing applications; deriving the user preference matching score from the information, the meta-data and weighting factors; providing a response to the media processing application including the derived user preference matching score; and taking an action, in the media processing application, responsive to the user preference matching score.

In another aspect of the present invention there is provided, a personalization engine for providing a user preference matching score for a media content item to any of a plurality of media processing applications, the apparatus comprising: a data processor for collecting user preference data from a plurality of data sources, for processing and storing the collected data as information in a data storage medium, and for providing a response to the media processing application including the user preference matching score; an application interface for receiving a user preference matching score request, including identification of the media content item and meta-data associated with the media content item, from a media processing application from the plurality of media processing applications; and a score generator for deriving the user preference matching score from the information, the meta-data and weighting factors; wherein the media processing application can take an action responsive to the user preference matching score.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1 is a schematic representation of an exemplary personalization engine in an exemplary cooperating environment in which it can be used.

FIG. 2 is a schematic representation of an exemplary group of collected data.

FIG. 3 is flow diagram representing the steps in an exemplary method for a personalization engine.

### DETAILED DESCRIPTION

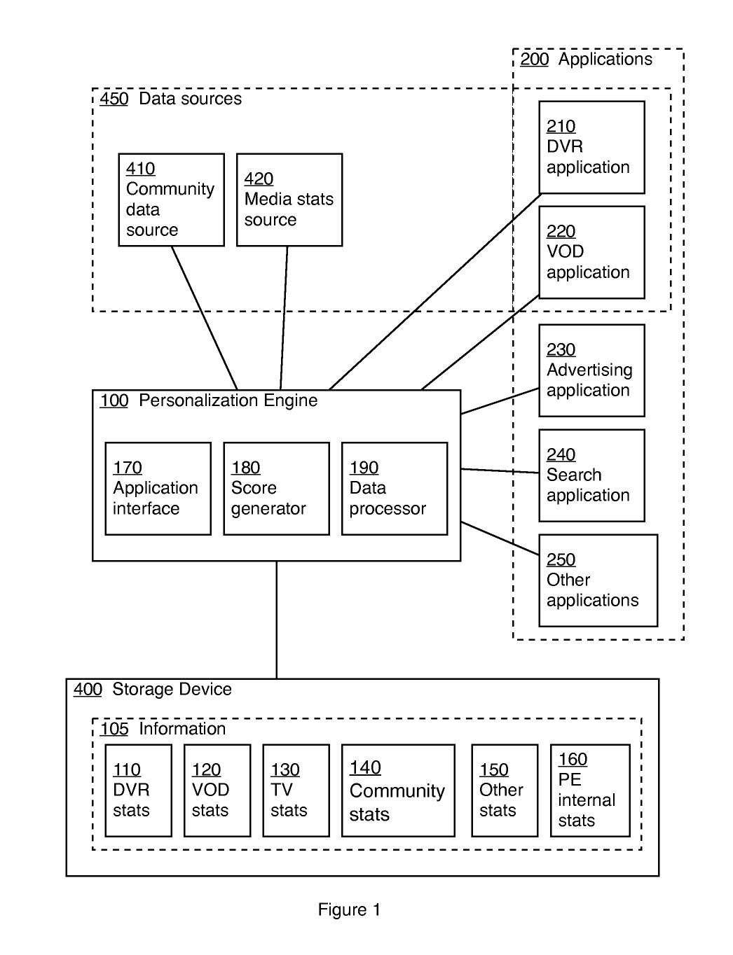

FIG. 1 is a schematic representation of an exemplary personalization engine 100 in an exemplary cooperating environment in which it can be used. A plurality of media processing applications 200 includes a digital video recorder (DVR) application 210, a video-on-demand (VOD) application 220, an advertising/promotion application 230, a search application 240, and other similar media processing applications represented by 250. Each of the preceding media processing applications has access to a plurality of media content items via, for example, a cable or satellite television feed, an Internet connection or a media storage/retrieval mechanism (e.g. a hard disk drive or CD/DVD player).

The personalization engine 100 collects and stores information 105 including DVR statistics 110, VOD statistics 120, television (TV) statistics 130, community statistics 140, other similar media related statistics represented by 150, and personalization engine internal statistics 160. The information 105 includes user expressed preferences and user usage history (i.e. usage of media content items) that are collectively referred to as user preferences in this document. The information 105 is collected from a plurality of data sources 450 including, for example, a community data source 410, a media stats source 420, the DVR application 210, and the VOD application 220. The data sources 450 can include the personalization engine 100 itself. In an alternative embodiment (not illustrated) the data sources 450 can include other similar sources of user preference information. The community data source 410 provides information that is derived from user preference information that is associated with other users of media content items (e.g. friends of the personalization engine 100 user). The media stats source 420 provides information that is derived from user preference information that is associated with usage of media content items by the general public. The user preference information associated with usage of media content items by the general public can be obtained from sources such as, for example, video rental stores (e.g. Blockbuster). For example, Blockbluster can provide statistics for the most popular movies with their customers for the current month.

Exemplary Blockbluster provided statistics can include:
Category: Horror (50%)
   Action (35%)
   Comedy (15%)
Price: 0-5$ (80%)
   5-10$ (20%)

The exemplary Blockbuster statistics indicate that customers prefer horror movies 50% of the time during this month and a price range of less than $5 80% of the time.

The personalization engine 100 can be implemented on any well-known computing platform such as, for example, a set-top-box (STB) (not shown) used in conjunction with a cable, satellite, Internet Protocol (IP) or other similar media distribution system (not shown). The personalization engine 100 comprises an application interface 170, a data processor 190 and a score generator 180.

The application interface 170 receives a request including identification of a media content item and associated meta-data from any one of the media processing applications 200 and provides a response to the requester (i.e. the media processing application 200) including a user preference matching score for the media content item. The media content item can be any electronically renderable media content item having meta-data such as, for example, a TV program, a movie, a still image, a digitally encoded book, and other similar media content items. The meta-data associated with the media content item for an exemplary TV program can include, for example, a title (e.g. Friends), a category (e.g. comedy), a duration (e.g. 30 minutes), a price (e.g. $0), a start time (e.g. 7:00 PM) and a rating (e.g. ‘G’). The user preference matching score is a representation of a derived likelihood that a user will have a preference for the media content item (e.g. the likelihood that the user would want to view the TV program). In a preferred embodiment of the personalization engine 100 the user preference matching score is expressed as a percentage wherein a lower percentage (e.g. 10%) signifies that the user is less likely to have a preference for the media content item and a higher percentage (e.g. 90%) signifies that the user is more likely to have a preference for the media content item. In an alternative embodiment of the personalization engine 100 the user preference matching score can be expressed as a numeric score within a pre-defined range, as a specific value selected from a pre-defined ordinal set of values or other similar mechanisms for expressing the strength of a match between the media content item and the user's preference for media content items.

Responsive to the user preference matching score contained in the response, the requesting application can take one or more actions, including taking no actions, with regard to the media content item. For example, when the requesting application is the DVR application 210 and the user preference matching score is above a pre-defined threshold (e.g. 80%) the DVR application 210 can autonomously (i.e. without user interaction) record a TV program (i.e. the media content item). The TV program is recorded because the user preference matching score indicates that it is likely that the user will want to view the TV program at some future time. When the requesting application is the VOD application 220 and the user preference matching score is above a pre-defined threshold (e.g. 65%) the VOD application 220 can propose (i.e. recommend) a TV program (i.e. the media content item) through a user interface (e.g. an Interactive Program Guide) for viewing selection by the user. When the requesting application is the advertising/promotion application 230, the identified media content item is an advertisement and when the user preference matching score is above a pre-defined threshold the advertising/promotion application 230 can present the advertisement to the user. When the requesting application is the search application 240, the identified media content item is a search result item and the search application 240 can use the user preference matching score to prioritize, sort, and filter the search result item, typically in relation to a plurality of other search result items, for presentation to the user.

The user preference matching score is derived from information 105 collected by the personalization engine. The information 105 is collected from a plurality of data sources 450 and stored by the data processor 190. The information 105 is stored in a storage device 400 such as, for example, non-volatile memory, a hard disk drive, or other similar persistent data storage device. The storage device 400 can be external to the personalization engine 100 or in an alternative embodiment the storage device 400 can be internal to the personalization engine 100. The information 105 is arranged into groupings, that correspond to the data source, such as, for example, DVR statistics 110, VOD statistics 120, TV statistics 130, community statistics 140, other similar media related statistics 150, and personalization engine internal statistics 160 for storage. The collected information 105 includes data pertaining to a plurality of pre-define fields that reflect the user's expressed preferences and the user's previous usage of other media content items. The fields can, for example, include: count (i.e. number of usages), identifier (a.k.a. ID), category (e.g. sports, action, horror, other) as a percentage distribution, price range (e.g. $0, $0-5, $5-10, $10-15) as a percentage distribution, duration range (e.g. 0-5 minutes (mins.), 5-10 mins., 10-30 mins., 30-60 mins., 60-120 mins.) as a percentage distribution, and rating (e.g. G, PG, AA, R) as a percentage distribution.

The information 105 is collected from a plurality of data sources 450. The data sources 450 can include the STB channel tuner, the digital video recorder (DVR) application 210, the video-on-demand (VOD) application 220, the community data source 410, the media stats source 420, and other similar sources of information regarding the users usage of media content items. Each data source 450 collects information relating to the user's media content preference in the form of either or both of expressed preferences and usage history. The usage history information for pre-determined time periods can, for example, be organized by the data source 450 as follows:
Source Type (e.g. Video/Audio/Pictures/Books/Other)
Source Name (e.g. DVR)
Usage By Time Period Information (i.e. information relates to one of these periods)
   12:00 am-3:00 am
   3:00 am-6:00 am
   6:00 am-9:00 am
   9:00 am-12:00 pm
   12:00 pm -3:00 pm
   3:00 pm-6:00 pm
   6:00 pm-9:00 pm
   9:00 pm-12:00 am
For each time period, the information source can, for example, provide the following information:
   Activity Count (eg. 15)
   Activity By Title
      Friends (e.g. 40%)
      Heroes (e.g. 25%)
   Activity By Id
      Episode 1234 (10%)
Activity By Category as a percentage

| | |
|---|---|
| Sports | (e.g. 40%) |
| Action | (e.g. 25%) |
| Horror | (e.g. 25%) |
| Other. | (e.g. 10%) |

Activity By Price as a percentage

| | |
|---|---|
| $0 | (eg. 70%) |
| $0-$5 | (eg. 20%) |
| $5-$10 | (eg. 5%) |
| $10-$15 | (eg. 0%) |

Activity Duration as a percentage

| | | |
|---|---|---|
| 0-5 | min | (eg. 5%) |
| 5-10 | min | (eg. 10%) |
| 10-30 | min | (eg. 10%) |
| 30-60 | min | (eg. 55%) |
| 60-120 | min | (eg. 20%) |

Activity By Rating

| | |
|---|---|
| G | (eg. 10%) |
| PG | (eg. 25%) |
| AA | (eg. 55%) |
| R | (eg. 10%) |

Each data source 450 provides the personalization engine 100 with data collected for a time period (e.g. 12:00 pm -3:00 pm) related to media content activities (e.g. viewing for the STB or recording for the DVR application 210) that occurred during that period. The data can preferably be sent to the personalization engine 100 after the time period ends. The data can include fields represented as a percent distribution of activity. For example, the activity by rating data can indicate that 10% of the activity in the time period related to media content with a ‘G’ rating while 25% of the activity related to ‘PG’ rated content, 55% to ‘AA’ rated and 10% to ‘R’ rated.

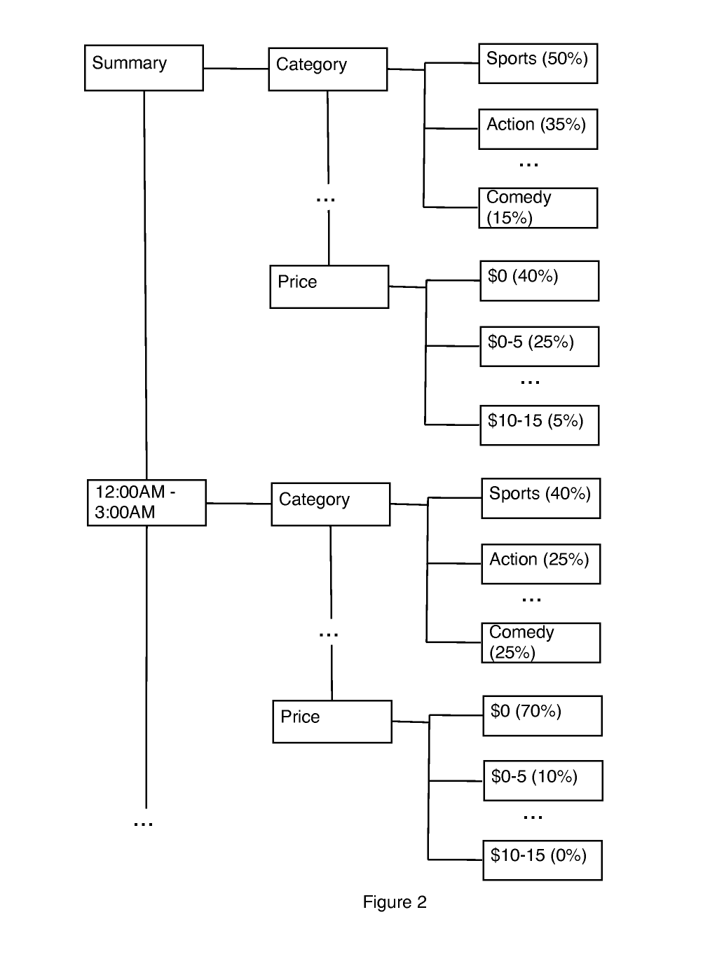

FIG. 2 is a schematic representation of an exemplary group of collected data from one data source 450. The collected data includes data for one or more time periods and a summary of the data for the one or more time periods. The data for each time period is organized into fields as described above. When data is collected form a data source 450 from which corresponding data was previously collected, the newly collected data replaces the previously collected data. Replacement of the previous data with the new data is preferable when the data source 450 is averaging the data over time or in some other way is ensuring that the data is keep current. In an alternative embodiment, the data processor 190 can process the newly collected data with corresponding previously collected data to calculate a time averaged value for the data fields and store the time averaged values. The summary is also organized by fields as described above and the data values in each field represent the average of the corresponding values for the one or more time periods.

The user preference matching score is derived by the score generator 180. In deriving the user preference matching score, different weighting factors can be assigned to data in each of the pre-defined fields in the information 105. The requesting application can specify a weighting factor to be applied for each of the pre-defined fields. Further weighting factors can be applied in deriving the user preference matching score based on the source of the data. When the requesting application has a corresponding information source (e.g. DVR application 210, VOD application 220), data from the corresponding information source can be given a higher weighting than data from other information sources. For example, in calculating the user preference matching score the data can be given weighting based on the source of the information as follows:

Source corresponds to requesting application−weight=40%,

Summary data−weight=30% (of 40%),

Time period data−weight=70% (of 40%);

Sources not corresponding to requesting application−weight=40%.
Data from each non-corresponding source receives a weight of 40% divide by number of non-corresponding sources;

Source having no corresponding media application−weight=20%,
Data from each source having no corresponding media application receives a weight of 20% divide by number of sources having no corresponding media application.

The requesting application can optionally specify that the derivation of the user preference matching score be based on collected information associated with a specified time period. The derivation of the user preference matching score be based on collected information associated with a specified time period can be expressed by weighting factors to be applied to time period data and to summary (i.e. not corresponding to a time period) data.

The requesting application can optionally provide feedback to the personalization engine 100. The feedback indicates if the user selected to use (e.g. to view) the media content item for which the user preference matching score was previously derived. By incorporating the feedback data, the personalization engine 100 can improve the derived user preference matching score for subsequent requests.

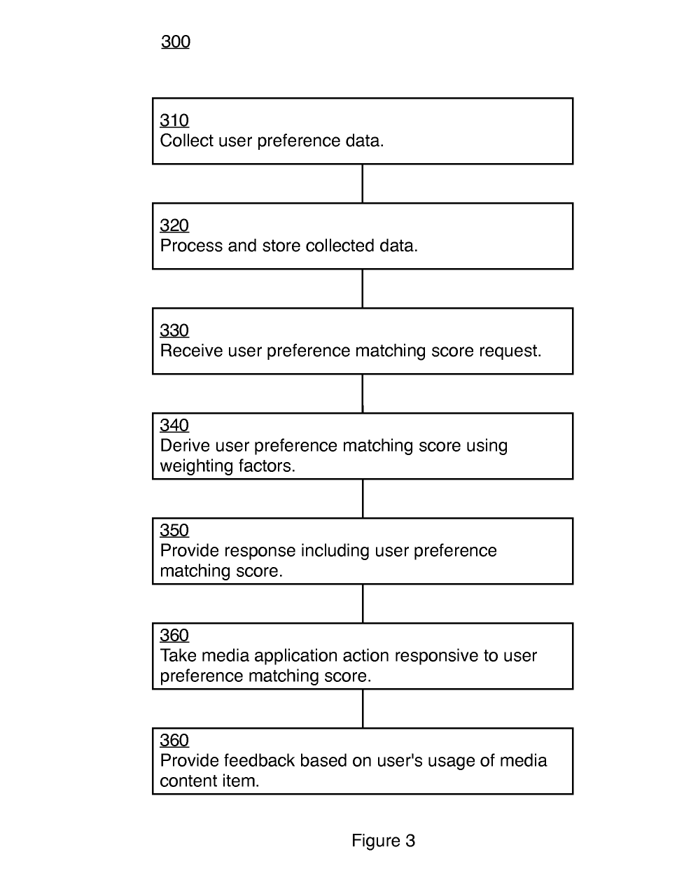

FIG. 3 is flow diagram representing the steps in an exemplary method 300 for the personalization engine 100. The method 300 can, for example, be implement using the personalization engine 100 as described above with reference to FIG. 1. In step 310 information pertaining to user preference (i.e. user expressed preferences and user usage of media content items) is collected from a plurality of information sources. The information sources include media processing applications such as, for example, the DVR application 210 and the VOD application 220 and other sources having no corresponding media application such as, for example, the community data source 410 and the media stats source 420. In step 320 the collected information 105 is organized and stored in a storage device. The information 105 is arranged according to the source of the information 105 and time periods associated with the information 105. In step 330 a request for a user preference matching score for an identified media content item is received. The request contains meta-data associated with the media content item. The request is received from any one of a plurality media processing applications 200. In step 340 the user preference matching score is derived from the information 105 stored in step 320. Derivation of the user preference matching score includes the application of weighting factors. Weighting factors can be provided by the requesting application as part of the request received in step 330. Weighting factors can be provided for each data field. Weighting factors can also be applied in accordance with: whether or not the source of collected information matches the requesting application; whether the source of collected information is a media processing application different from the requesting application; and whether the source of collected information is not a media processing application. Weighting factors can also be applied to data based on time period and to summary (i.e. not corresponding to a time period) data. In step 350 a response is sent to the requesting application including the user preference matching score derived in step 340. In step 360 the requesting application can take (including failing to take) an action responsive to the user preference matching score provided in the response. For example when the requesting application is the DVR application 210 the action can include recording the media content item identified in the request when the user preference matching score is above a predefined threshold. In step 370, the requesting application can optionally provide feedback to the personalization engine 100 for inclusion in the stored information 105 that indicates whether or not the user used (e.g. viewed) the media content item identified in the request received in step 330.

The method 300 according to the present invention can be implemented by a computer program product comprising computer executable program instructions stored on a computer-readable storage medium.

For illustrative purposes, two sample calculations of user preference matching scores follow. The following formulas are used in the two sample calculations.

$$Formulas for generating application and personalization weight . \\ PE\_Weight := 40 \% * ( 100 \% - App\_Input \_Weight )$$

$$Other\_App \_Weight := \frac{( 100 \% - App\_Input \_Weight - PE\_Weight )}{( Number\_Of \_App - 1 )} \\ Formulas for generating field score : \\ Field\_Score := ( Input\_app \_field \_stat * Input\_app \_category \_weight ) + ( PE\_app \_field \_stat * PE\_app \_weight ) + ( Other\_app \_ 1 \_field \_stat * Other\_app \_weight ) + ( Other\_app \_ 2 \_field \_stat * Other\_app \_weight ) + … \\ Formulas for generating overall score : \\ Total\_score := ( Field\_ 1 \_Score * Field\_ 1 \_Weight ) + ( Field\_ 2 \_Score * Field\_ 2 \_Weight ) + … \\ Formulas for generating Final result score : \\ Final\_score := ( General\_Score * General\_Weight ) + ( Time\_Base \_Score * Time\_Base \_Weight )$$

Wherein:
PE_Weight is a weighting factor applied to data have the personalization engine as source.
Appl_Input_Weight is a weighting factor applied to data having the requesting media processing application as source.
Other_App_Weight is a weighting factor applied to data having as source a media processing application other than the requesting media processing application.
Number_Of_App is the number of media processing applications and are also data sources.
Field_Score is a derived score associated with the data for a specific field.
Input_app_field_stat is the data value for a specific field having the requesting media processing application as source.
Input_app_category_weight is a weighing factor applied to the data value for a specific field and having the requesting media processing application as source.
PE_appl_field_stat is the data value for a specific field having the personalization engine as source.
PE_app_weight is a weighing factor applied to the data value for a specific field and having the personalization engine as source.
Other_app_N_field_stat is the data value for a specific field having as source media processing application ‘N’ which is other than the requesting media processing application.
Field_N_Score is a score derived for a field ‘N’ using the formula for ‘Field_Score’ and the corresponding field information (i.e. stats).
Field_N_weight is a weighting factor applied to a field ‘N’ and specified by the requesting media processing application.
Final_Score is a derived score that represents the user preference matching score to be provided in the response to the requesting media processing application.
General_Score is a component of the ‘Final_Score’ derivation that is derived using the ‘Total_Score’ formula and the non-time-period based field values.
General_Weight is a weighting factor applied to the General_Score and specified by the requesting media processing application. For example, when the requesting media processing application requests that the user preference matching score be derived without regard to time period the General_Weight is 100% and the Time_Base_Weight is 0%.
Time_Base_Score is a component of the ‘Final_Score’ derivation that is derived using the ‘Total_Score’ formula and the time period based field values.
Time_Base_Weight is a weighting factor applied to data for a specified time period and specified by the requesting media processing application.

For the purposes of the sample calculations the personalization engine 100 has the following information 105 stored in the storage medium 400. The information 105 was collected from three data sources 450—the DVR application 210, the VOD application 220 and the personalization engine 100 internal statistics. Each of the data sources 210, 220, 100 has provided data having two fields (i.e. category and price) for three time periods (i.e. 6:00 am-4:00 pm, 4:00 pm-12:00 am; 12:00 am-6:00 am).

DVR

| | Category | | | Price | | |
|---|---|---|---|---|---|---|
| | Sports | Action | Children | $0-5 | $5-10 | Over $10 |
| Overall | 60% (6) | 20% (2) | 20% (2) | 100% (10) | 0% | 0% |
| | 6:00 am-4:00 pm | | | | | |
| Time | 0% | 0% | 100% (2) | 100% (2) | 0% | 0% |
| Based | | | | | | |
| | 4:00 pm-12:00 am | | | | | |
| | 83% (5) | 17% (1) | 0% | 100% (2) | 0% | 0% |
| | 12:00 am-6:00 am | | | | | |
| | 50% (1) | 50% (1) | 0% | 100% (2) | 0% | 0% |

VOD

| | Category | | | Price | | |
|---|---|---|---|---|---|---|
| | Sports | Action | Children | $0-5 | $5-10 | Over $10 |
| Overall | 60% (6) | 10% (1) | 30% (3) | 80% (8) | 20% (2) | 0% |
| | 6:00 am-4:00 pm | | | | | |
| Time Based | 25% (1) | 0% | 75% (3) | 100% (4) | 0% | 0% |
| | 4:00 pm-12:00 am | | | | | |
| | 100% (5) | 0% | 0% | 80% (4) | 20% (1) | 0% |
| | 12:00 am-6:00 am | | | | | |
| | 0% | 100% (1) | 0% | 0% | 100% (1) | 0% |

Personal Engine Internal Stats

| | | | | Price | | |
|---|---|---|---|---|---|---|
| | Category | | | | | Over |
| | Sports | Action | Children | $0-5 | $5-10 | $10 |
| Overall | 50% (5) | 20% (2) | 30% (3) | 90% (9) | 10% (1) | 0% |
| | 6:00 am-4:00 pm | | | | | |
| Time | 33% (1) | 0% | 67% (2) | 100% (3) | 0% | 0% |
| Based | | | | | | |
| | 4:00 pm-12:00 am | | | | | |
| | 66% (4) | 17% (1) | 17% (1) | 66% (4) | 34% (2) | 0% |
| | 12:00 am-6:00 am | | | | | |
| | 0% | 100% (1) | 0% | 100% (1) | 0% | 0% |

In the first sample calculation the request for a user preference matching score is received from the DVR application 210. The meta-data associated with the identified media content item indicates that item is in the sports category and has a price of $0. The DVR application 210 indicates that DVR sourced information 105 is to be given a weight of 40%, that the category field is to be given a weight of 100% and the price field a weight of 0%. The DVR application 210 further indicates that the user preference matching score is to be calculated for the time period corresponding to 2:00 pm and that the corresponding time period (i.e. 6:00 am-4:00 pm) is to be given a weight of 100%. The calculation is as follows:

$$\begin{matrix}PE\_weight := 40 \% * ( 100 \% - 40 \% ) \\ := 24 \%\end{matrix}$$

$$\begin{matrix}Other\_App \_Weight := ( 100 \% - 40 \% - 24 \% ) / ( 2 - 1 ) \\ := 36 \%\end{matrix}$$

$$\begin{matrix}General\_Category \_Score := ( 60 \% * 4 \; 0 \% ) + ( 50 \% * 24 \% ) + ( 60 \% * 36 \% ) \\ := 24 \% + 12 \% + 21.6 \% \\ := 57.6 \%\end{matrix}$$

$$\begin{matrix}General\_Price \_Score := ( 100 \% * 4 \; 0 \% ) + ( 90 \% * 24 \% ) + ( 80 \% * 36 \% ) \\ := 40 \% + 21.6 \% + 28.8 \% \\ := 90.4 \%\end{matrix}$$

$$\begin{matrix}General\_Total \_Score := ( 57.6 \% * 10 \; 0 \% ) + ( 90.4 \% * 0 \% ) \\ := 57.6 \%\end{matrix}$$

$$\begin{matrix}Time\_Base \_Category \_Score := ( 0 \% * 4 \; 0 \% ) + ( 33 \% * 24 \% ) + ( 25 \% * 36 \% ) \\ := 0 \% + 7.9 \% + 9 \% \\ := 16.9 \%\end{matrix}$$

$$\begin{matrix}Time\_Base \_Price \_Score := ( 100 \% * 4 \; 0 \% ) + ( 90 \% * 24 \% ) + ( 100 \% * 36 \% ) \\ := 40 \% + 21.6 \% + 36 \% \\ := 97.6 \%\end{matrix}$$

$$\begin{matrix}Time\_Base \_Total \_Score := ( 16.9 \% * 100 \% ) + ( 97.6 \% * 0 \% ) \\ := 16.9 \%\end{matrix}$$

$$\begin{matrix}Final\_Score := ( 57.6 \% * 0 \% ) + ( 16.9 \% * 100 \% ) \\ := 16.9 \%\end{matrix}$$

As a result of the first sample calculation a user preference matching score of 16.9% (i.e. the final score) is returned to the DVR application 210.

In the second sample calculation the request for a user preference matching score is received from the VOD application 220. The meta-data associated with the identified media content item indicates that item is in the children category and has a price of $3. The VOD application 220 indicates that VOD sourced information 105 is to be given a weight of 50%, that the category field is to be given a weight of 60% and the price field a weight of 40%. The VOD application 220 further indicates that the user preference matching score is to be calculated for the time period corresponding to 8:00 am and that the corresponding time period (i.e. 6:00 am-4:00 pm) is to be given a weight of 70%. The calculation is as follows:

$$\begin{matrix}PE\_weight := 40 \% * ( 100 \% - 50 \% ) \\ := 20 \%\end{matrix}$$

$$\begin{matrix}Other\_App \_Weight := ( 100 \% - 40 \% - 20 \% ) / ( 2 - 1 ) \\ := 40 \%\end{matrix}$$

$$\begin{matrix}General\_Category \_Score := ( 30 \% * 4 \; 0 \% ) + ( 30 \% * 20 \% ) + ( 20 \% * 40 \% ) \\ := 12 \% + 6 \% + 8 \% \\ := 26 \%\end{matrix}$$

$$\begin{matrix}General\_Price \_Score := ( 90 \% * 4 \; 0 \% ) + ( 80 \% * 24 \% ) + ( 100 \% * 36 \% ) \\ := 36 \% + 19.2 \% + 36 \% \\ := 91.2 \%\end{matrix}$$

$$\begin{matrix}General\_Total \_Score := ( 26 \% * 6 \; 0 \% ) + ( 91.2 \% * 40 \% ) \\ := 15.6 \% + 36.5 \% \\ := 52.1 \%\end{matrix}$$

$$\begin{matrix}Time\_Base \_Category \_Score := ( 75 \% * 4 \; 0 \% ) + ( 67 \% * 20 \% ) + ( 100 \% * 40 \% ) \\ := 30 \% + 13.4 \% + 40 \% \\ := 83.4 \%\end{matrix}$$

$$\begin{matrix}Time\_Base \_Price \_Score := ( 100 \% * 4 \; 0 \% ) + ( 100 \% * 20 \% ) + ( 100 \% * 40 \% ) \\ := 40 \% + 20 \% + 40 \% \\ := 100 \%\end{matrix}$$

$$\begin{matrix}Time\_Base \_Total \_Score := ( 83.4 \% * 60 \% ) + ( 100 \% * 40 \% ) \\ := 50 \% + 40 \% \\ := 90 \%\end{matrix}$$

$$\begin{matrix}Final\_Score := ( 52.1 \% * 30 \% ) + ( 90 \% * 70 \% ) \\ := 15.6 \% + 63 \% \\ := 78.6 \%\end{matrix}$$

As a result of the second sample calculation a user preference matching score of 78.6% (i.e. the final score) is returned to the VOD application 220.

In the above description examples relating to television programs as media content items and viewing of the television programs as media content usage have been used for illustrative purposes. The apparatus and method for the personalization engine described in this document are equally applicable to other types of media content items including, but not limited to, moving images, still images, and digitally encoded books.

It will be apparent to one skilled in the art that numerous modifications and departures from the specific embodiments described herein may be made without departing from the spirit and scope of the present invention.

1. A method for a personalization engine for providing a user preference matching score for a media content item to any of a plurality of media processing applications, the method comprising the steps of:
collecting user preference data from a plurality of data sources;
processing and storing the collected data as information in a data storage medium;
receiving a user preference matching score request, including identification of the media content item and meta-data associated with the media content item, from a media processing application from the plurality of media processing applications;
deriving the user preference matching score from the information, the meta-data and weighting factors;
providing a response to the media processing application including the derived user preference matching score; and
taking an action, in the media processing application, responsive to the user preference matching score.

2. The method of claim 1, wherein the media content item is any one of: a television program; a movie; a still image; and a digitally encoded book.

3. The method of claim 1, wherein the media content item is a television program and the meta-data comprises any one or more of: a title; a category; a duration; a price; and a start time.

4. The method of claim 1, wherein the user preference data includes one or more of: user expressed preferences; and user usage history data.

5. The method of claim 1, wherein the user preference data is organized by: fields, pre-defined time periods and data sources.

6. The method of claim 1, wherein the plurality of data sources includes one or more of the plurality of media processing applications.

7. The method of claim 1, wherein the plurality of data sources includes a community data source providing user preference data for a pre-defined plurality of media users.

8. The method of claim 1, wherein the plurality of data sources includes a media stats data source providing user preference data representative of a general public of media users.

9. The method of claim 5, wherein the user preference matching score request includes weighting factors to be applied based on one or more of: the source of data, the fields of data, and the time period of data.

10. The method of claim 1, wherein the media processing application provides feedback, to be included in the collected data, indicating on the usage of the media content item by the user.

11. A personalization engine for providing a user preference matching score for a media content item to any of a plurality of media processing applications, the apparatus comprising:
a data processor for collecting user preference data from a plurality of data sources; for processing and storing the collected data as information in a data storage medium; and for providing a response to the media processing application including the user preference matching score;
an application interface for receiving a user preference matching score request, including identification of the media content item and meta-data associated with the media content item, from a media processing application from the plurality of media processing applications; and
a score generator for deriving the user preference matching score from the information, the meta-data and weighting factors;
wherein the media processing application can take an action responsive to the user preference matching score.

12. The personalization engine of claim 11, wherein the media content item is any one of: a television program; a movie; a still image; and a digitally encoded book.

13. The personalization engine of claim 11, wherein the media content item is a television program and the meta-data comprises any one or more of: a title; a category; a duration; a price; and a start time.

14. The personalization engine of claim 11, wherein the user preference data includes one or more of: user expressed preferences; and user usage history data.

15. The personalization engine of claim 11, wherein the user preference data is organized by: fields, pre-defined time periods and data sources.

16. The personalization engine of claim 11, wherein the plurality of data sources includes one or more of the plurality of media processing applications.

17. The personalization engine of claim 11, wherein the plurality of data sources includes a community data source providing user preference data for a pre-defined plurality of media users.

18. The personalization engine of claim 11, wherein the plurality of data sources includes a media stats data source providing user preference data representative of a general public of media users.

19. The personalization engine of claim 15, wherein the user preference matching score request includes weighting factors to be applied based on one or more of: the source of data, the fields of data, and the time period of data.

20. The personalization engine of claim 11, wherein the application interface further receives from the media processing application feedback, to be included in the collected data, indicating on the usage of the media content item by the user.
